(19) United States
(12) Patent Application Publication
(10) Pub. No.: US 2010/0280142 A1
(43) Pub. Date: Nov. 4, 2010

(54) Shaped Information-Storage Material of Photopolymers and Methods for Making Same

(76) Inventors: Cheng-Fu Chen, Yangmei Township (TW); Jang-Jyi Jiang, Jhong Li City (TW); Ren-Jie Chiou, Jhong Li City (TW); Yu-Hsien Lin, Jhong Li City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/756,340

(22) Filed: Apr. 8, 2010

(30) Foreign Application Priority Data
Apr. 10, 2009 (TW) 98111905

(51) Int. Cl. C08F 2/46; C08J 5/00

(52) U.S. Cl. 522/28; 264/331.18

(57) ABSTRACT

A method for making shaped information-storage material of photo polymers includes mixing powdery azobisisobutyronitrile (AIBN) and powdery acenaphthenequinone (AQ) into liquid monomers of methyl methacrylate (MMA) and stirring a mixture of the AIBN, AQ, and MMA to form a solution. The azobisisobutyronitrile (AIBN) serves as a thermo polymerization initiator, and the acenaphthenequinone (AQ) serves as a photo polymerization initiator. The solution is filtered to remove the saturated photo polymerization initiator. Then, the filtered solution is poured into a shaping container and heated in the shaping container to make solid, shaped information-storage material of photo polymers. The shaping container is then opened to remove the shaped information-storage material of photo polymers. The shaped information-storage material of photo polymers includes two flat lateral sides.

### BACKGROUND OF THE INVENTION

The present invention relates to shaped information-storage material using photopolymers and methods for making this information-storage material and, more particular, shaped material of AQ doped PMMA photopolymer for used in information/hologram storage and methods for making the same.

Holography has been developed for more than sixty years and is well applied in several fields including holographic real time display, holographic interferometry, holographic optic elements, and information storage. Since development and improvement in storage materials for holograms will result in further developments in holography application, convenience of use and improvements in diffraction efficiency is the main focus of research and development in this field.

Conventional hologram storage materials include silver halides for photography, dichromated gelatin (DOG), photoresistors, photoconductor thermoplastic films, and photopolymers. Reviewing the properties of each of these materials will illustrate the advantages of photopolymers. To start with, the diameter of the silver halides for making hologram plates is smaller than 0.1 μm. The silver halides not only absorb but also scatter light. Although the scattering interference is not important, the image contrast in high-quality hologram plates is reduced. This can be addressed by requiring reflective hologram plates out of a substrate having antihalo coating, however, the antihalo coating must be removed in advance with a solvent (such as alcohol) in a dark room. Dichromated gelatin is not as popular as silver halides because it is difficult to make hologram plates out of dichromated gelatin while avoiding moisture. Positive and negative photoresistors generally used in hologram plates can record interference fringes, and a master plate with undulating patterns can be produced by development. Then, electroforming is carried out on the master plate recording the hologram message to make a metal mold. Finally, the metal mold can be utilized to produce relatively cheap thermoplastic materials through pressing. However, the high initial cost (including films and equipment) is the main disadvantage. On the other hand, the photoconductor thermoplastic films allow cheap mass reproduction. Unfortunately, the thermoplastic materials have poor response in low frequency and, thus, have a limited range in resolution. Furthermore, the area of the final hologram plate is too small for information storage (or backup) purposes. Photopolymer (in non-bulk form) are widely used for hologram recording today. Another good candidate for information storage is photorefractive crystals such as LiNbO₃ and BaTiO₃, however, they are very expensive due to difficulties in mass production.

Photopolymers have excellent refraction index change and light sensitivity. Despite its low cost, bulk photopolymers are not widely being used at the present time for information storage. In 1998, a research team led by Dr. Psaltis at the California Institute of Technology published a photopolymer of 9,10-phenanthrenequinone (PQ) doped polymethyl methacrylate (PMMA) as a medium for storage of holograms. Research of PMMA doped with zinc methylacrylate (ZnMA) and PQ for increasing light sensitivity has been conducted recently.

However, in making PQ/PMMA with PQ powders, azobisisobutyronitrile (AIBN) powders, and liquid methyl methacrylate (MMA), exposure of PQ is prohibited during preparation of PQ or during the information storing procedure using PQ/PMMA. This is due to the fact that an exposure of PQ will start a rapid photochemical reaction. As a result mass production and practical use of PQ/PMMA is not practical.

### BRIEF SUMMARY OF THE INVENTION

An objective of the present invention is to provide a shaped information-storage material of photopolymers and methods for making the same, wherein acenaphthenequinone (AQ) and azobisisobutyronitrile (AIBN) are doped into methyl methacrylate (MMA) to form solid AQ/PMMA with a diffraction efficiency of 80%. Acenaphthenequinone (AQ) has a highly stable chemical structure suitable for mass production and practical use.

To achieve the above objective, the present invention provides a shaped information-storage material for photopolymers including liquid monomers of methyl methacrylate (MMA), a thermo polymerization initiator, and a photo polymerization initiator. The thermo polymerization initiator is azobisisobutyronitrile (AIBN). The liquid monomers of methyl methacrylate and the thermo polymerization initiator are mixed to form PMMA. The photo polymerization initiator is acenaphthenequinone (AQ) and is distributed within the PMMA through the fabrication procedure to form a solid, shaped information-storage material.

A method for making the shaped information-storage material of photopolymers according to the teachings of the present invention includes mixing powdery azobisisobutyronitrile (AIBN) and powdery acenaphthenequinone (AQ) into liquid monomers of methyl methacrylate (MMA) and stirring a mixture of the AIBN, AQ, and MMA to form a solution. The azobisisobutyronitrile (AIBN) serves as a thermo polymerization initiator, and the acenaphthenequinone (AQ) serves as a photo polymerization initiator. The solution is filtered to remove saturated photo polymerization initiator. Then the filtered solution is poured into a shaping container and heated to make solid, shaped storage material of photo polymers. The shaping container is then opened to remove the shaped information-storage material. The shaped information-storage material thus formed includes two flat lateral sides.

The present invention will become obvious in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a perspective view of a shaping container utilized for making shaped information-storage material of photo polymers according to the present invention.

FIG. 2 shows an exploded, perspective view of the shaping container of FIG. 1.

FIG. 3 shows a perspective view of shaped information-storage material of photopolymers according to the present invention.

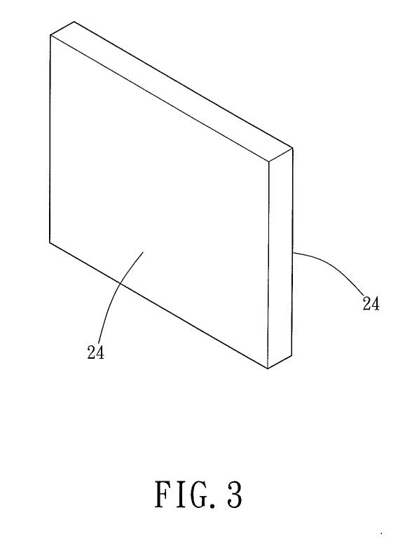

All figures are drawn for ease of explanation of the present invention only; the extensions of the figures with respect to number, position, relationship, and dimensions of the parts to form the preferred embodiments will be explained or will be within the skill of the art after the present invention has been read and understood. Further, the exact dimensions, timing, temperature, chemical composition, preparation of material, molding method, improvement of diffraction efficiency, large scale of fabrication and industrialized production of this material to conform to specific chemical composition, preparation, fabrication sequence, and other requirements will likewise be within the skill of the art after the present invention has been read and understood.

### DETAILED DESCRIPTION OF THE INVENTION

A method according to the preferred teachings of the present invention can be utilized to make shaped storage material of photopolymers that is more suitable for mass production and practical use. First, 0.005-5% by weight of powdery azobisisobutyronitrile (AIBN, serving as a thermo polymerization initiator) and 0.005-5% by weight of powdery acenaphthenequinone (AQ, serving as a photo polymerization initiator) are mixed into 90-99.99% by weight of liquid monomers of methyl methacrylate (MMA). In a preferred example, 0.05-2.5% by weight of powdery azobisisobutyronitrile (AIBN) and 0.05-2.5% by weight of powdery acenaphthenequinone (AQ) are mixed into 95-99.99% by weight of liquid monomers of methyl methacrylate (MMA).

The molecular formulae and chemical formulae of the three chemical substances are as follows:

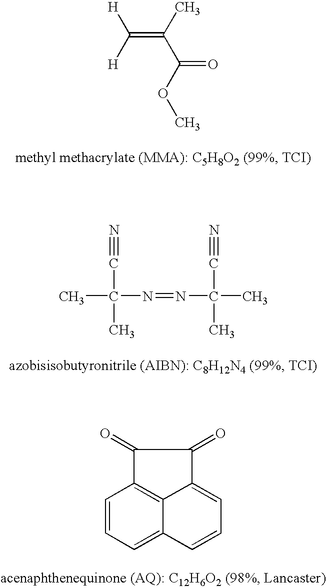

The mixture of the AIBN, AQ, and MMA is stirred to form a solution. After mixing and stirring the solution is filtered to remove the saturated photopolymerization initiator. The filtered solution is poured into a shaping container and heated to make solid, shaped information-storage material of photopolymers. Then the shaping container is opened to remove the shaped storage material. The shaped storage material is suitable practical use because it has a diffraction efficiency of 80% and because the chemical structure of AQ is stable.

During the procedures of making the information-storage material, when AIBN is subjected to heat the link breaks between the two nitrogen atoms in the center, generating nitrogen and two free radicals, as shown in the following chemical equation. At this time, the monomer of MMA reacts with the free radials and becomes a larger molecule carrying a free radical.

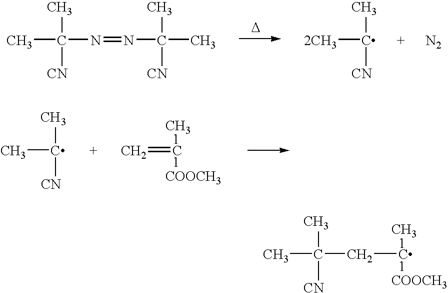

After linking (chain propagation), since there is still a free radical another linking (chain propagation) reaction occurs to further grow the molecule, as shown in the following chemical equation.

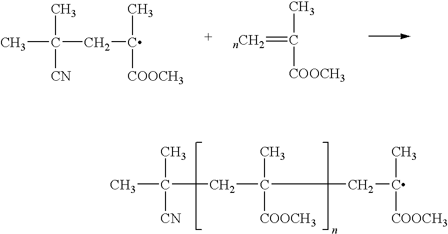

The chain propagation stops when the growing molecule carrying a free radical reacts with another growing molecule in a manner shown in the following chemical equation. There are two types of mechanisms for stopping the propagation chain: coupling and disproportionation. The composition of these two mechanisms depends on the polymer types and the reaction temperature. With regard to PMMA, the higher the reaction temperature, the higher ratio of disproportionation to coupling.

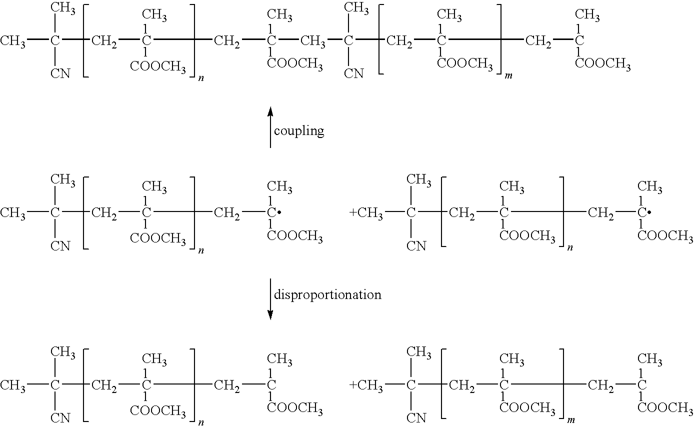

After the above thermal reaction, most of the monomers of MMA react with AIBN to form PMMA. Since AQ is not a participant during this heating process, AQ distributes evenly in the shaped information-storage material. Not all of the monomers of MMA are polymerized into PMMA, thus, residual monomers of MMA and AQ are evenly distributed in the shaped storage material. These two compounds become elements which are responsible for the information-storage mechanism.

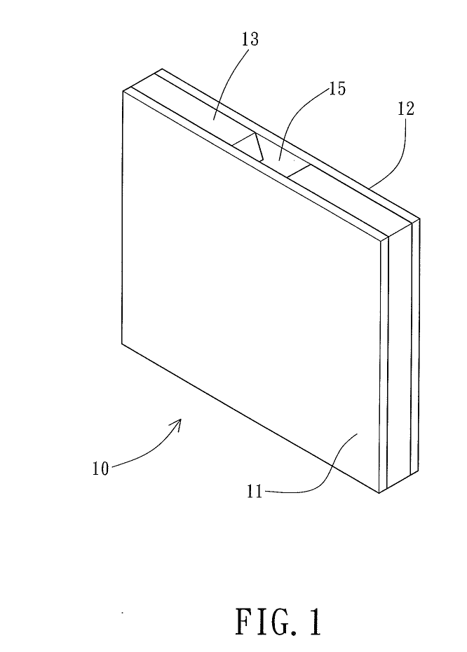

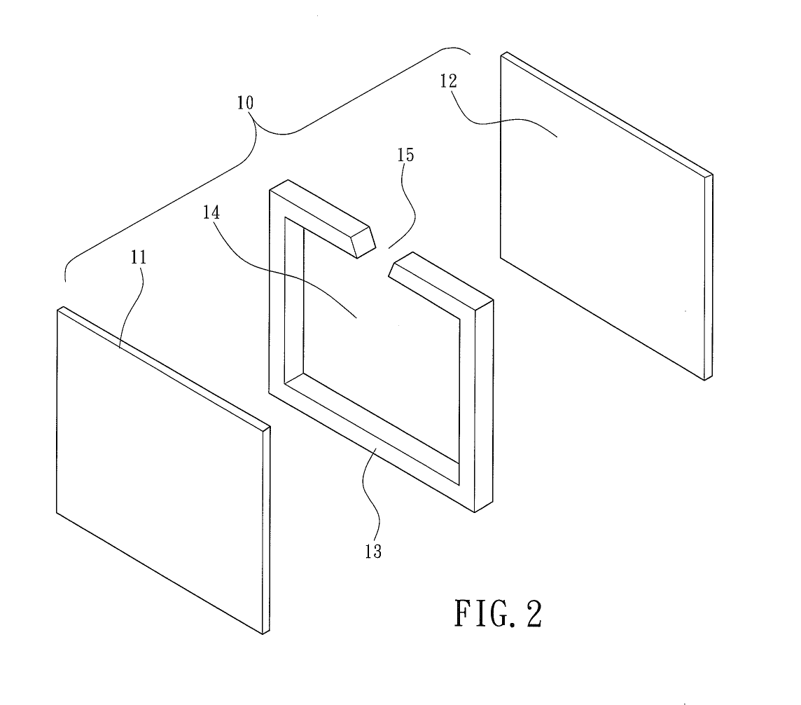

When making AQ/PMMA (AQ doped PMMA), the monomers of MMA must be purified to remove stabilizers and impurities. Furthermore, a shaping container 10 must be prepared in advance. In the preferred form shown in FIGS. 1 and 2, the shaping container 10 includes two side glass panels 11 and 12 and a middle frame 13 sandwiched between the glass panels 11 and 12. The middle frame 13 defines a cavity with two openings 14 in two sides thereof and includes a filling port 15 in a top side thereof. The middle frame 13 is made of Teflon, resistant to strong acids and strong alkalis. The clean glass panels 11 and 12 are bonded to two sides of the middle frame 13 by white glue to cover and seal the side openings 14 of the middle frame 13.

Example 1: AQ 0.3 wt %; AIBN 0.52 wt %; MMA 99.2 wt %, monomers.

AQ and AIBN were mixed into purified MMA, and the solution was sealed by tinfoil to avoid exposure to the light. The solution was placed on an ultrasonic vibrator and subjected to ultrasonic vibration for half an hour to speed up solution of AQ and AIBN in the monomers of MMA. The solution was placed into a heater/stirrer and heated at 30° C. (or 20-34° C.) and stirred for a day at a speed of 300 rpm. After stirring, the solution was filtered with a 0.2 μm filter to remove saturated AQ and impurities from the solution. After filtration, the solution was poured into the shaping container 10 sealed with tinfoil to avoid exposure of the solution. Then, the shaping container 10 was placed into a thermostat in which the solution was heated at 39° C. (or 32-60° C.) for 12 hours. The AQ/PMMA material obtained in this way results in better diffraction efficiency.

A solid block of AQ/PMMA was formed in the shaping container 10 after the above procedure. The shaping container 10 was then placed in a refrigerator for 20 minutes so that the glass panels 11 and 12 become easily separated from the solid block of AQ/PMMA due to cold shrinkage. The AQ/PMMA removed from the shaping container 10 and was wrapped by tinfoil to avoid adverse affect to the quality of the AQ/PMMA due to long-term exposure to the light. The shaped information-storage material of photo polymers thus formed includes two flat lateral sides 24.

In use, the solid block of AQ/OMMA thus obtained can be exposed to light as needed to produce shaped storage material suitable for storage of holograms. When the material in AQ/PMMA is illuminated by light having an appropriate wavelength, the AQ material and the monomers of MMA undergo a photochemical reaction (see below) while AQ does not react with PMMA. Thus AQ will produce two free radicals after illumination.

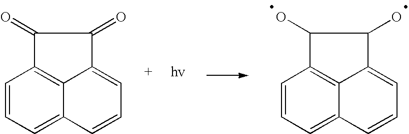

After a series of experiments and improvements, it was found that the saturated light-induced refractive index of AQ/PMMA is about 7.12×10⁻⁴, when using AQ 0.3 wt %, AIBN 0.5 wt %, and MMA 99.2 wt % as the composition. The diffractive efficiency (intensity of diffracted light/intensity of reading light) is about 80%. Furthermore, since the chemical structure of AQ is more stable than PQ, obvious photochemical reaction (a change of the color into yellow) will not occur until AQ has been placed under visual light for a day. After storing holograms in the material, the holographic fringe will not fade off until the solid block has been placed under fluorescent light. Specifically, the diffraction efficiency was 80% in the first day, 57% in the second day, 37% in the third day, 19% in the fourth day, and 4% in the fifth day. It took two days to produce AQ/PMMA which is one day shorter than that required for PQ/PMMA. Furthermore, the temperature for producing AQ/PMMA is 6° C. lower than that for PQ/PMMA. Thus AQ/PMMA is much more suitable for mass production. Also it is more practical in use as compared with PQ/PMMA.

The invention disclosed herein may be embodied in other specific forms without departing from the spirit or general characteristics thereof, some of which forms have been indicated, such that the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A shaped information-storage material for photopolymers comprising liquid monomers of methyl methacrylate (MMA), a thermo polymerization initiator, and a photo polymerization initiator, with the thermo polymerization initiator being azobisisobutyronitrile (AIBN), with the liquid monomers of methyl methacrylate and the thermo polymerization initiator being mixed to form polymethyl methacrylate (PMMA), with the photo polymerization initiator being acenaphthenequinone (AQ) and distributed in the PMMA, forming solid, shaped information-storage material of photopolymers.

2. The shaped information-storage material of photopolymers as claimed in claim 1, with the liquid monomers of methyl methacrylate being 90-99.99% by weight, with powdery thermo polymerization initiator being 0.005-5% by weight, and with powdery photo polymerization initiator being 0.005-5% by weight.

3. The shaped information-storage material of photopolymers as claimed in claim 2, with the liquid monomers of methyl methacrylate being 95-99.9% by weight, with the powdery thermo polymerization initiator being 0.05-2.5% by weight, and with the powdery photo polymerization initiator being 0.05-2.5% by weight.

4. The shaped information-storage material of photopolymers as claimed in claim 3, with the information-storage material including residual liquid monomers that are not thermo polymerized.

5. The shaped information-storage material of photopolymers as claimed in claim 4, with the storage material including at least two flat lateral sides.

6. A method for making shaped information-storage material of photo polymers comprising:
mixing powdery azobisisobutyronitrile (AIBN) and powdery acenaphthenequinone (AQ) into liquid monomers of methyl methacrylate (MMA) and stirring a mixture of the AIBN, AQ, and MMA to form a solution, with the azobisisobutyronitrile (AIBN) serving as a thermo polymerization initiator, with the acenaphthenequinone (AQ) serving as a photo polymerization initiator;
filtering the solution to remove the saturated photo polymerization initiator;
pouring the filtered solution into a shaping container and heating the filtered solution in the shaping container to make solid, shaped information-storage material of photo polymers; and
opening the shaping container to remove the shaped information-storage material of photo polymers.

7. The method for making the shaped information-storage material for photopolymers as claimed in claim 6, with mixing the powdery azobisisobutyronitrile (AIBN) and the powdery acenaphthenequinone (AQ) into liquid monomers of methyl methacrylate (MMA) including mixing 0.005-5% by weight of the powdery azobisisobutyronitrile (AIBN) and 0.005-5% by weight of the powdery acenaphthenequinone (AQ) into 90-99.99% by weight of the liquid monomers of methyl methacrylate (MMA).

8. The method for making the shaped information-storage material of photopolymers as claimed in claim 7, with mixing the powdery azobisisobutyronitrile (AIBN) and the powdery acenaphthenequinone (AQ) into liquid monomers of methyl methacrylate (MMA) including mixing 0.05-2.5% by weight of the powdery azobisisobutyronitrile (AIBN) and 0.05-2.5% by weight of the powdery acenaphthenequinone (AQ) into 95-99.9% by weight of the liquid monomers of methyl methacrylate (MMA).

9. The method for making the shaped information-storage material of photopolymers as claimed in claim 8, with stirring the mixture including stirring the mixture at 20-34° C.

10. The method for making the shaped information-storage material of photopolymers as claimed in claim 9, further comprising: proceeding with ultrasonic vibration of the mixture before stirring the mixture.

11. The method for making the shaped information-storage material of photopolymers as claimed in claim 7, with heating the filtered solution in the shaping container including heating the filtered solution in the shaping container at 32-60° C.

12. The method for making the shaped information-storage material of photopolymers as claimed in claim 7, with making the solid, shaped storage material including cooling the shaping container to separate the solid, extraction of shaped information-storage material from the shaping container, obtaining the solid, shaped information-storage material with at least two flat sides.

13. The method for making the shaped information-storage material of photopolymers as claimed in claim 12, further comprising: packaging the shaped storage material to avoid exposure of the shaped information-storage material to light.
